(19) United States
(12) Patent Application Publication
(10) Pub. No.: US 2026/0283889 A1
(43) Pub. Date: Sep. 24, 2026

(54) CRUTCH WITH EASILY ADWSTABLE LENGTH

(71) Applicant: Sang Hyun HAN, Gyeonggi-do (KR)

(72) Inventor: Sang Hyun HAN, Gyeonggi-do (KR)

(21) Appl. No.: 19/479,841

(22) PCT Filed: Jun. 9, 2023
(86) PCT No.: PCT/KR2023/007907

§ 371 Date: Oct. 29, 2025

(30) Foreign Application Priority Data
May 4, 2023 (KR) 10-2023-0058072

(51) Int. Cl. A61H 3/02; F16B 7/10

(52) U.S. Cl. CPC A61H 3/02; F16B 7/10; A61H 2201/0192; A61H 2201/1635; A61H 2201/5053

(57) ABSTRACT

A crutch with easily adjustable length, includes: an upper body having a support base; a lower body that is coupled to a lower portion of the upper body; a locking member that is installed on one side of the upper body; an elastic member interposed between the upper body and the locking member to provide an elastic force to the locking member in an inward direction of the upper body; a power transmission member formed on one side of the locking member; and a driving unit that is installed on one side of the upper body.

### TECHNICAL FIELD

The present invention relates to a crutch with easily adjustable length, and more particularly, to a crutch capable of maintaining portability by preventing an increase in weight, while allowing the user to adjust its length easily through a simple operation.

### BACKGROUND ART

In general, crutches are tools that help people with walking difficulties, including patients with leg injuries, to walk on their own without the help of others. Users select the crutches that fit their height, place them under their armpits, and walk by distributing the load on their legs to the crutches.

However, existing crutches are manufactured with a fixed length, so in situations where the length of the crutches needs to be adjusted, such as on slopes or stairs, the users must bend over or hold the upper part of the crutches with their hands to place the crutches on the ground. This action is not only very cumbersome, but also poses a risk of safety accidents as the crutches are not stably supported under the armpit.

Accordingly, In the related field, in order to solve the above-mentioned problems, a crutch having an adjustable length has been developed, and one example thereof is disclosed in Korean Utility Model Registration No. 20-0447607 (hereinafter referred to as “conventional length-adjustable crutch”).

FIG. 1A is an exploded perspective view of a conventional length-adjustable crutch, and FIG. 1B is a perspective view of a conventional length-adjustable crutch.

As shown in FIG. 1A, a conventional adjustable length crutch (100) includes a body portion (110) having a support portion (111) formed at the top thereof and coupling holes (112) formed in the vertical direction at one side of the lower portion thereof; and a leg portion (120) having a plurality of elastic buttons (121) formed at one side so as to protrude and retract at regular intervals in the vertical direction, at least one of which is inserted into the coupling hole (112), and a soft cushion member (122) formed at the lower end thereof.

In the case of the conventional adjustable length crutch (100), the user holds one side of the crutch with one hand, presses the elastic button (121) with the other hand and hides it inside the leg portion (120), and moves the leg portion (120) in either the upward or downward direction to adjust the length. Then, the elastic button (121) protrudes outward due to the restoring force and is inserted into one of the plurality of coupling holes (112), thereby fixing the adjusted length of the crutch.

As described above, the conventional adjustable crutch (100) has an advantage in that its length can be adjusted according to the user's situation. However, in order to adjust the length, the user must hold the crutch with both hands and move the leg portion (120) up and down while pressing the elastic button (121). Accordingly, it is very difficult for the user to adjust the length of the crutch alone, and there is also a problem in that a considerable amount of time is required for length adjustment.

Accordingly, there is a growing demand in the industry for crutches that can maintain portability by preventing weight gain, while allowing the length to be adjusted with simple operations.

### SUMMARY OF THE INVENTION

Accordingly, the present invention has been made in an effort to solve the above-mentioned conventional problems, and the purpose of the present invention is to provide a crutch with easily adjustable length capable of maintaining portability by preventing an increase in weight, while allowing the user to adjust its length easily through a simple operation.

According to one aspect of the present invention so as to accomplish these objects, there is provided to a crutch with easily adjustable length, including an upper body having a support base formed at an upper portion thereof so as to be supported on one side of a user's body, a receiving space formed therein, and an open lower portion; a lower body that is coupled to a lower portion of the upper body so as to be movable in a vertical direction, and has a plurality of engaging portions formed in the longitudinal direction on one side thereof; a locking member that is installed on one side of the upper body so as to be movable in inward and outward directions of the upper body, and is configured such that, when moved inwardly, one side thereof is engaged with the engaging portion to restrain a movement of the lower body; an elastic member interposed between the upper body and the locking member to provide an elastic force to the locking member in an inward direction of the upper body; a power transmission member formed on one side of the locking member; and a driving unit that is installed on one side of the upper body so as to be movable in a vertical direction, and is configured to press one side of the power transmission member when moved in either of upward or downward directions, thereby causing the locking member to move outwardly from the upper body.

In addition, the power transmission member is formed in a circular plate shape and is rotatably coupled to one side of the locking member, a plurality of teethes being formed along an outer circumferential surface thereof; and the driving unit includes a body portion, which is installed on one side of the upper body so as to be movable in the vertical direction, wherein an inclined surface inclined outwardly with respect to the upper body is formed at an end corresponding to the power transmission member and, when moved toward the power transmission member, one side thereof where the inclined surface is formed presses the power transmission member, thereby moving the locking member outwardly from the upper body; and a teeth coupling portion formed at an upper portion of the body portion to be gear-engaged to one side of the power transmission member.

In addition, the driving unit is installed on one side of the upper body and further comprises a support portion formed on one side of an upper surface thereof and gear-engaged with one side of the power transmission member so as to be supported thereon.

In addition, the power transmission member is coupled to one side of the locking member and has, at one side thereof, an inclined surface inclined outwardly from the upper body; and the driving unit is movably installed on one side of the upper body in a vertical direction and, when moved in either of upward or downward directions, presses the inclined surface to move the locking member outwardly from the upper body.

In addition, the upper body further includes a handle protruding from one side thereof to provide a gripping area; and the driving unit has, at one side thereof, a trigger-shaped operating portion configured to support a user's finger.

### Advantageous Effects

According to the present invention as described above, the crutch can maintain its conventional portability while minimizing an increase in weight due to its simple structure, and the length of the crutch can be very easily adjusted merely by pressing or pulling one side of the driving unit with a finger.

### BRIEF DESCRIPTION OF DRAWINGS

The above and other objects, features and advantages of the present invention will be more apparent from the following detailed description taken in conjunction with the accompanying drawings, in which:

FIG. 1A is an exploded perspective view of a conventional length-adjustable crutch;

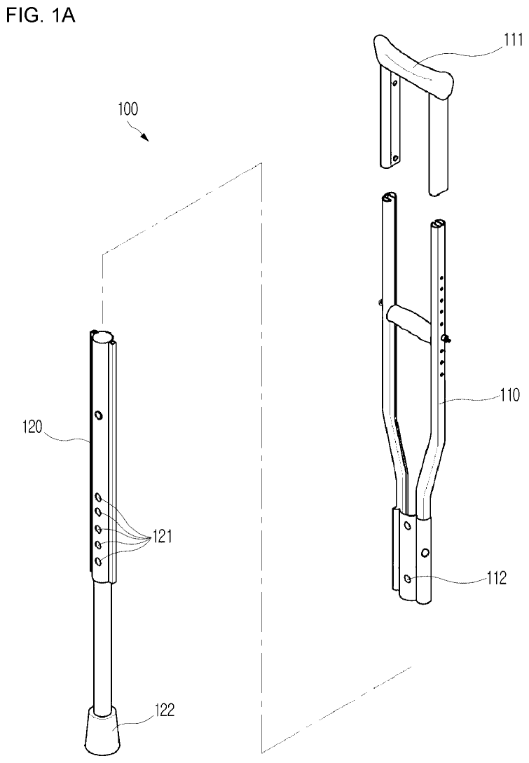

FIG. 1B is a perspective view of a conventional length-adjustable crutch;

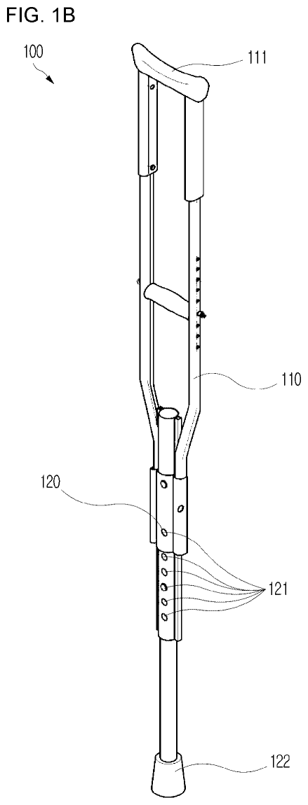

FIG. 2 is a perspective view of a crutch with easily adjustable length according to an embodiment of the present invention;

FIG. 3 is an exploded perspective view of a crutch with easily adjustable length according to an embodiment of the present invention;

FIG. 4 is a cross-sectional view of a crutch with easily adjustable length according to an embodiment of the present invention;

FIG. 5 is a diagram illustrating a state in which the driving unit moves upward according to an embodiment of the present invention;

FIG. 6 illustrates a state in which the lower body slides relative to the upper body according to an embodiment of the present invention;

FIG. 7 illustrates a state in which the locking member and the driving unit return to their initial positions according to an embodiment of the present invention;

FIG. 8 is a partial sectional view of a crutch with easily adjustable length according to another embodiment of the present invention; and

FIG. 9 illustrates an operation of releasing the engagement state of the engaging portions according to another embodiment of the present invention.

### DETAILED DESCRIPTION OF THE INVENTION

Hereinafter, preferred embodiments of the present invention will be described in detail with reference to the accompanying drawings.

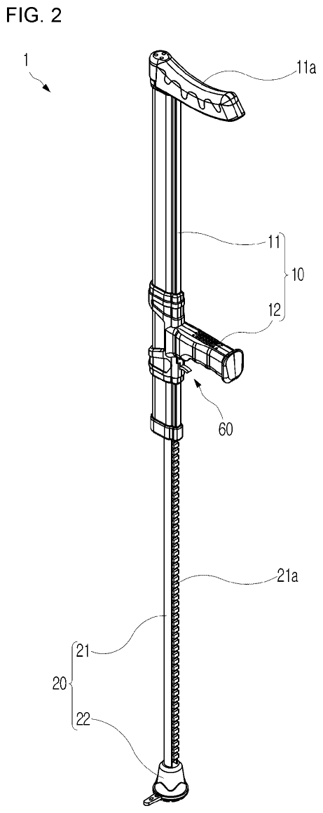

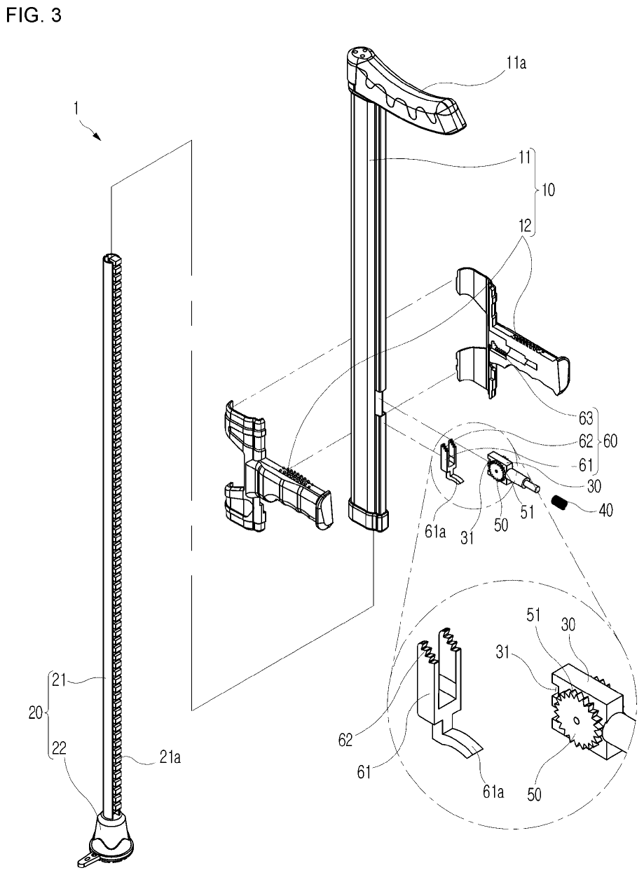

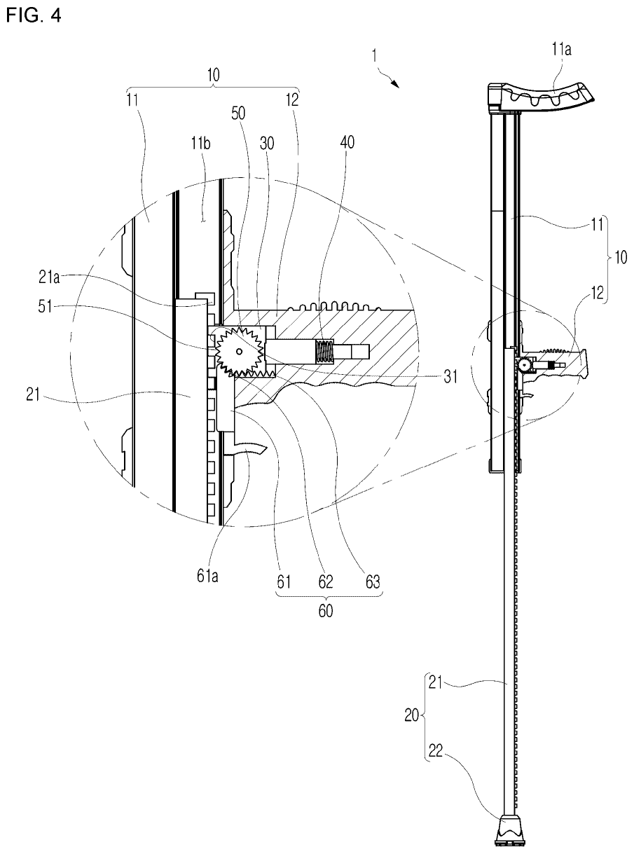

FIG. 2 is a perspective view of a crutch with easily adjustable length according to an embodiment of the present invention, FIG. 3 is an exploded perspective view of a crutch with easily adjustable length according to an embodiment of the present invention, and FIG. 4 is a cross-sectional view of a crutch with easily adjustable length according to an embodiment of the present invention.

As shown in FIG. 2 to FIG. 4, a crutch (1) with easily adjustable length according to one embodiment of the present invention includes an upper body (10), a lower body (20), a locking member (30), an elastic member (40), a power transmission member (50), and a driving unit (60).

The upper body (10) includes a first body portion (11), which is formed in a generally cylindrical rod shape, and a handle (12) that protrudes outwardly from one side of an outer surface of the first body portion (11).

The first body portion (11) has, at its upper end, a support base (11a) configured to support on one side of a user's body, preferably under the user's armpit; a receiving space (11b) formed therein, and an open lower portion.

The handle (12) extends outwardly from one side of the outer surface of the first body portion (11), at a position suitable for gripping by the user's hand while the support base (11a) is placed under the armpit. This handle (12) provides a gripping area that allows the user to comfortably and easily hold the crutch (1).

The lower body (20) is formed as a cylindrical rod having a diameter corresponding to the inner diameter of the upper body (10). It includes a second body portion (21) having a plurality of engaging portions (21a) formed at one side thereof along a longitudinal direction at regular intervals, and a cushion portion (22) formed at a lower end of the second body portion (21) and supported on a ground. The cushion portion (22) is preferably made of a soft material such as rubber, so that the impact generated when the crutch contacts the ground can be absorbed.

The locking member (30) is movably installed inside the handle (12) in the inward and outward directions of the first body portion (11) and includes a groove (31) corresponding in shape to some of the plurality of engaging portions (21a) formed at a front end thereof.

When the locking member (30) moves inwardly toward the first body portion (11), the groove (31) engages with some of the plurality of engaging portions (21a) to restrain the vertical movement of the second body portion (21). When the locking member (30) moves outwardly from the first body portion (11), it disengages from the engaging portion (21a), thereby releasing the locked state of the second body portion (21).

The elastic member (40) is interposed between an inner surface of one side of the handle (12) and a rear end of the locking member (30). It provides an elastic force to the locking member (30) toward the inward direction of the first body portion (11) that is, the direction in which the groove (31) of the locking member (30) is engaged with the engaging portion (21a), so that the locked state of the second body portion (21) is maintained, when no external force is applied.

The power transmission member (50) is formed in a substantially circular plate shape, with a plurality of teeth (51) formed along its outer circumference, and is rotatably coupled to one side of the locking member (30). When one side of the power transmission member (50) is pressed by the driving unit (60) described later, the power transmission member (50) rotates and simultaneously transmits the pressing force received from the driving unit (60) to the locking member (30), thereby moving the locking member (30) outwardly from the first body portion (11).

The driving unit (60) includes a pressing portion (61) that is movably installed on one side of the upper body (10) in a vertical direction, a teeth coupling portion (62) formed at an upper portion of the pressing portion, and a support portion (63) installed inside the handle (12) below the power transmission member (50).

The pressing portion (61) is formed in a substantially rod-like shape, with its upper end formed to be inclined downward toward an outer side of the upper body (10), and is disposed at a position corresponding to one side of the power transmission member (50) that faces the engaging projection. When the pressing portion (61) moves upward, the inclined upper end presses the power transmission member (50) outwardly from the first body portion (11), thereby releasing the locked state of the lower body (20) caused by the locking member (30).

In addition, a trigger-shaped operating portion (61a) is formed at the lower end of the pressing portion (61), allowing the user to pull the operating portion (61a) while gripping the handle (12), thereby moving the pressing portion (61) upward and enhancing usability thereof.

The teeth coupling portion (62) is formed at the upper inclined region of the pressing portion (61) in a shape corresponding to the teethes (51) of the power transmission member (50). When the pressing portion (61) moves upward, the teeth coupling portion (62) engages with the teethes (51) to prevent slipping between the inclined upper end of the pressing portion (61) and the power transmission member (50), thereby allowing the pressing force of the pressing portion (61) to be stably transmitted to the power transmission member (50).

The support portion (63) is formed in a block shape having teethes on its upper surface and is configured to have a predetermined length in a direction corresponding to the moving direction of the locking member (30). When the locking member (30) moves inwardly or outwardly with respect to the first body (11), the support portion (63) supports and guides the power transmission member (50) in a state where it is gear-engaged with the power transmission member (50), thereby enabling stable movement of the locking member (30).

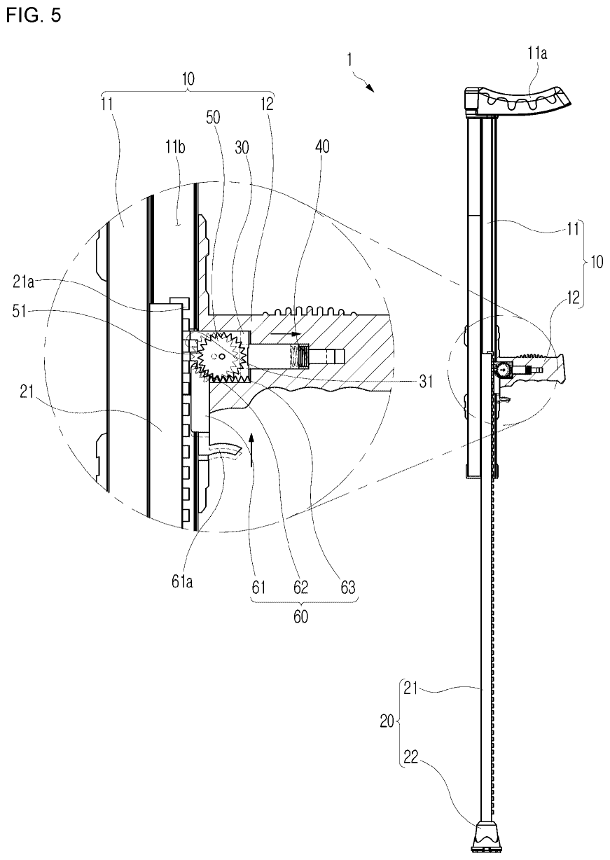

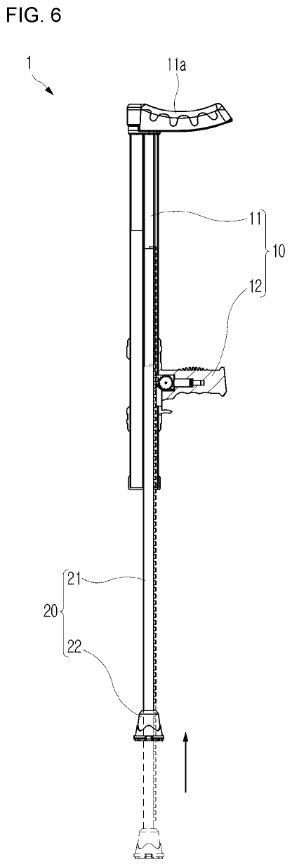

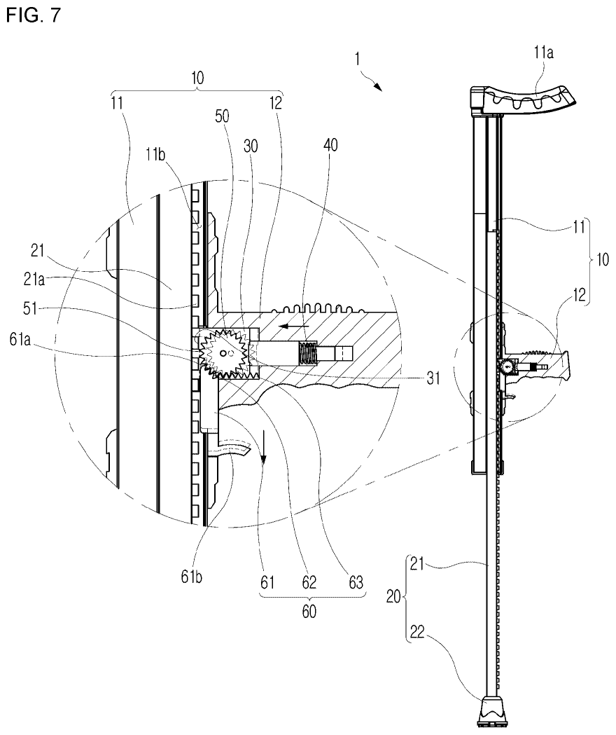

FIG. 5 is a diagram illustrating a state in which the driving unit moves upward according to an embodiment of the present invention, FIG. 6 illustrates a state in which the lower body slides relative to the upper body according to an embodiment of the present invention, and FIG. 7 illustrates a state in which the locking member and the driving unit return to their initial positions according to an embodiment of the present invention.

The operation of the crutch (1) with easily adjustable length according to an embodiment of the present invention, having the above configuration, will now be described with reference to FIG. 5 to FIG. 7.

First, the user supports the support base (11a) under the armpit and grips the handle (12) for walking. At this time, the locking member (30) is maintained in an inwardly moved state by the elastic force of the elastic member (40), i.e., in a state where it is engaged with the engaging portion (21a) of the lower body (20), thereby providing stable support during walking.

Afterwards, when the user desires to adjust the length of the crutch (1), the user pulls the operating portion (61a) with the index finger. The teeth coupling portion (62) remains engaged with the teethes (51) of the power transmission member (50) while the driving unit (60) moves upward, and the inclined upper end of the pressing portion (61) presses the power transmission member (50) outwardly from the upper body (10).

The power transmission member (50), pressed by the driving unit (60), moves outwardly from the upper body (10) while being supported by the support portion (63), and the locking member (30) coupled to the power transmission member (50) also moves outwardly, thereby releasing engagement with the engaging portions (21a).

The user may then grip one side of the lower body (20) with the other hand and move the lower body (20) vertically relative to the upper body (10) to adjust the length of the crutch (1).

When the length adjustment thereof is completed, the user releases the operating portion (61a) that was being pulled. Upon release of the external force applied to the driving unit (60), the locking member (30) moves inwardly toward the upper body (10) under the elastic force provided by the elastic member (40), and engages with the engaging portion (21a), thereby fixing the adjusted length of the crutch (1).

Simultaneously, the power transmission member (50) moves inwardly of the upper body (10) together with the restraining member (30) and returns to the initial position, and the driving member (60) moves downward as the inclined upper end of the inclined driving member (60) is pressed by the power transmission member (50) returning to the initial position, so that the driving member (60) also returns to the initial position.

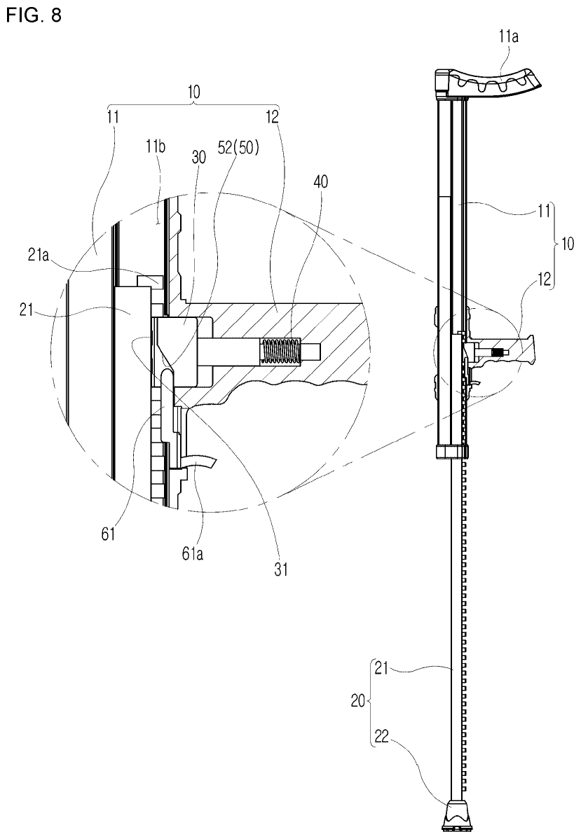

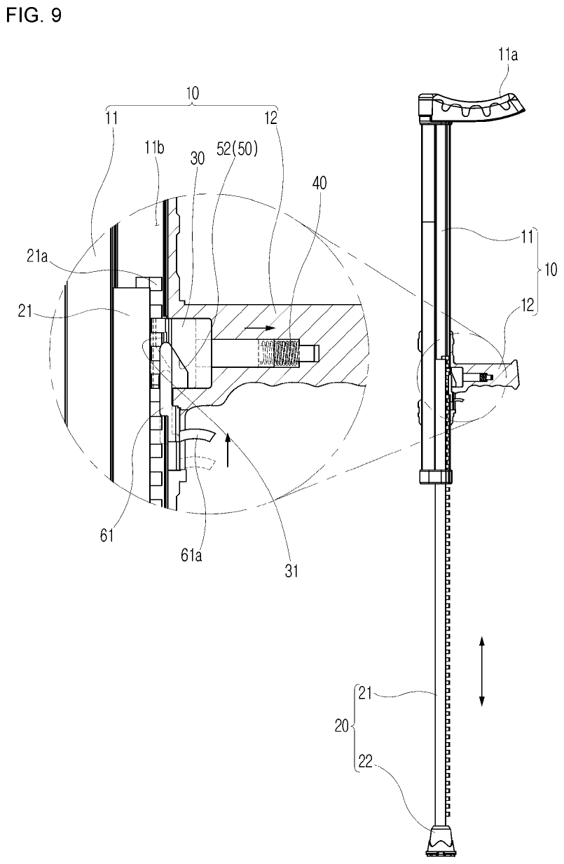

FIG. 8 is a partial sectional view of a crutch with easily adjustable length according to another embodiment of the present invention, and FIG. 9 illustrates an operation of releasing the engagement state of the engaging portions according to another embodiment of the present invention.

The basic structure of the embodiment shown in FIG. 8 is the same as that of the embodiments shown in FIG. 2 to FIG. 7, except that the structure for moving the power transmission member outwardly from the upper body is configured differently.

As shown in FIG. 8, in this embodiment, the power transmission member (50) is formed in a generally block shape and coupled to one side of the locking member (30). An inclined surface (52) is formed at one side of the power transmission member (50) facing the driving unit (60), the inclined surface (52) being inclined outwardly from the upper body (10).

Unlike the previous embodiment, the driving unit (60) omits the teeth coupling portion (62), and the upper end of the pressing portion (61) is formed in an upwardly curved shape.

When the driving unit (60) moves upward due to the operation of the user's operating portion (61a), the upper end of the pressing portion (61) comes into contact with the inclined surface (52) of the power transmission member (50). As shown in FIG. 9, with the upper end of the pressing portion (61) in contact with the inclined surface (52), the driving unit (60) moves upward, thereby pressing the power transmission member (50) outwardly with respect to the upper body (10).

Accordingly, the power transmission member (50) moves outwardly, and the locking member (30) coupled thereto also moves outwardly from the upper body (10), thereby releasing engagement with the engaging portions (21a).

The other structural elements are identical to those of the basic embodiment described above, and therefore further detailed description thereof will be omitted.

Although the present invention has been described with reference to the preferred embodiments mentioned above, various modifications and variations are possible without departing from the spirit and scope of the invention.

Accordingly, the scope of the appended claims will include such modifications or variations as fall within the spirit of the present invention.

1. A crutch with easily adjustable length, comprising:
an upper body having a support base formed at an upper portion thereof so as to be supported on one side of a user's body, a receiving space formed therein, and an open lower portion;
a lower body that is coupled to a lower portion of the upper body so as to be movable in a vertical direction, and has a plurality of engaging portions formed in the longitudinal direction on one side thereof;
a locking member that is installed on one side of the upper body so as to be movable in inward and outward directions of the upper body, and is configured such that, when moved inwardly, one side thereof is engaged with the engaging portion to restrain a movement of the lower body;
an elastic member interposed between the upper body and the locking member to provide an elastic force to the locking member in an inward direction of the upper body;
a power transmission member formed on one side of the locking member; and
a driving unit that is installed on one side of the upper body so as to be movable in a vertical direction, and is configured to press one side of the power transmission member when moved in either of upward or downward directions, thereby causing the locking member to move outwardly from the upper body.

2. The crutch with easily adjustable length of claim 1, wherein
the power transmission member is formed in a circular plate shape and is rotatably coupled to one side of the locking member, a plurality of teethes being formed along an outer circumferential surface thereof; and
the driving unit comprises:
a pressing portion, which is installed on one side of the upper body so as to be movable in the vertical direction, wherein, when moved toward the power transmission member, a one side thereof where an inclined surface is formed presses the power transmission member, thereby moving the locking member outwardly from the upper body; and
a teeth coupling portion formed at an upper portion of the pressing portion to be gear-engaged to one side of the power transmission member.

3. The crutch with easily adjustable length of claim 1, wherein the driving unit is installed on one side of the upper body and further comprises a support portion formed on one side of an upper surface thereof and gear-engaged with one side of the power transmission member so as to be supported thereon.

4. The crutch with easily adjustable length of claim 1, wherein the power transmission member is coupled to one side of the locking member and has, at one side thereof, an inclined surface inclined outwardly from the upper body; and
the driving unit is movably installed on one side of the upper body in a vertical direction and, when moved in either of upward or downward directions, presses the inclined surface to move the locking member outwardly from the upper body.

5. The crutch with easily adjustable length of claim 1, wherein the upper body further includes a handle protruding from one side thereof to provide a gripping area; and
the driving unit has, at one side thereof, a trigger-shaped operating portion configured to support a user's finger.
